(19) United States
(12) Patent Application Publication
(10) Pub. No.: US 2007/0262041 A1
(43) Pub. Date: Nov. 15, 2007

(54) Bottle Assembly and a Vent Device Therefor

(76) Inventor: Stephen Michael Smith, Shropshire (GB)

Correspondence Address: SCHMEISER, OLSEN & WATTS, 22 CENTURY HILL DRIVE, SUITE 302, LATHAM, NY, 12110, US

(21) Appl. No.: 10/599,916

(22) PCT Filed: Apr. 13, 2005
(86) PCT No.: PCT/GB05/01421

§ 371 Date: Jul. 12, 2007

(30) Foreign Application Priority Data
Apr. 13, 2004 (GB) 0408135.2

(51) Int. Cl. B65D 47/32

(52) U.S. Cl. 215/11.5; 137/843

(57) ABSTRACT

A bottle assembly including a bottle having an opening for receiving a fluid, a closure for closing the opening, the closure having a fluid outlet to enable egress of the fluid from the bottle, and a vent device, the vent device comprising a one-way valve, a vent path being defined by the one way valve from the exterior to the interior of the bottle different from the fluid outlet, whereby the vent path permits air to vent into the bottle on creation of a partial vacuum as a result of the fluid passing to the exterior of the bottle via the fluid outlet. Another aspect of the present invention relates to a vent device for a bottle, the vent device comprising a vent aperture and a one-way valve in fluid communication with the vent aperture, a vent path being defined by the vent aperture (FIG. 1)

The present invention relates to a bottle assembly, and to a vent device for use with a bottle assembly, particularly but not exclusively limited to a baby bottle assembly.

Known baby bottle assemblies comprise a bottle having a chamber for receiving liquid feed, a fluid outlet in the form of a teat, and a collar to secure the teat onto the bottle. When feeding a baby from the bottle, the liquid feed is sucked through the teat by the baby. As the liquid feed is removed from the bottle, a partial vacuum is created in the bottle, thereby creating a pressure differential between the exterior of the bottle and the chamber. When the baby stops feeding, the pressure differential causes air to be vented into the bottle via the teat, thus creating a mixture of liquid feed and air in the teat. When the baby resumes feeding, the baby ingests this mixture, which causes problems such as colic, stomach ache, and wind. There is also the possibility that the teat will collapse as a result of the pressure differential. Furthermore, more effort is required to suck from the bottle as the partial vacuum is created, which causes discomfort to the baby, and increases feeding time.

To overcome this problem, known baby bottle assemblies employ some form of venting system which enables air to be vented into the bottle remote from the teat.

However, a problem with known venting systems is that liquid feed can leak from the bottle via the venting system.

Furthermore, known venting systems are complex, involving multiple components, which firstly increases the likelihood of liquid leaking from the bottle since individual components of the system need to be sealed together, and secondly increases manufacturing and assembly costs. In addition, it is more difficult to sterilise the bottle assembly when it is complex, and thus there is a risk of the bottle assembly becoming contaminated.

A similar problem also arises with sports drink bottles, where the partial vacuum created firstly results in more effort being required when drinking, and secondly causes the bottle to collapse, with the potential that the bottle may become damaged and leak.

An object of the present invention is to provide an improved bottle assembly.

According to the present invention there is provided a bottle assembly including a bottle having an opening for receiving a fluid, a closure for closing the opening, the closure having a fluid outlet to enable egress of the fluid from the bottle, and a vent device, the vent device comprising a one-way valve, a vent path being defined by the one-way valve from the exterior to the interior of the bottle, the vent path being different from the fluid outlet, whereby the vent path permits air to vent into the bottle on creation of a partial vacuum as a result of the fluid passing to the exterior of the bottle via the fluid outlet.

The use of such a bottle assembly provides a simple means by which air can be vented into the bottle and which, at the same time, prevents fluid leaking from the bottle.

According to another aspect of the present invention there is provided a vent device for a bottle, the vent device comprising a vent aperture and a one-way valve in fluid communication with the vent aperture, a vent path being defined by the vent aperture.

Advantageously, the vent device can be added to known bottle assemblies to provide venting of air into the bottle without having to modify the components of the bottle assembly in any way.

In addition to baby bottles, it will be appreciated that any bottle in which a partial vacuum is created as fluid is removed will benefit from the present invention, for example, in the case of sports drinks bottles, less effort is required when drinking from the bottle.

The present invention also applies to bottles which need to be squeezed rather than sucked for example, some drink bottles, or bottles for dispensing other fluids such as shampoo.

The invention will now be described by way of example only, with reference to the accompanying drawings, in which:

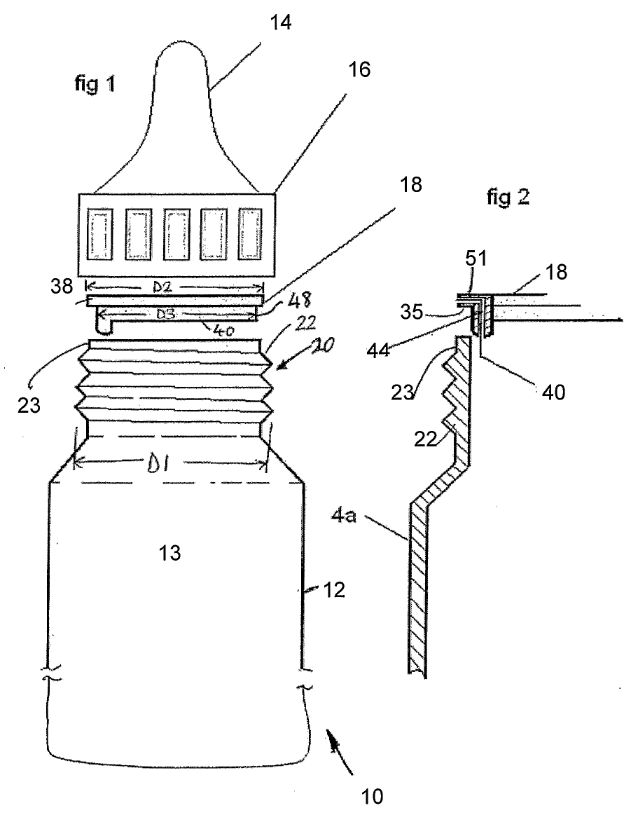

FIG. 1 is a front view showing a bottle assembly awarding to the present invention,

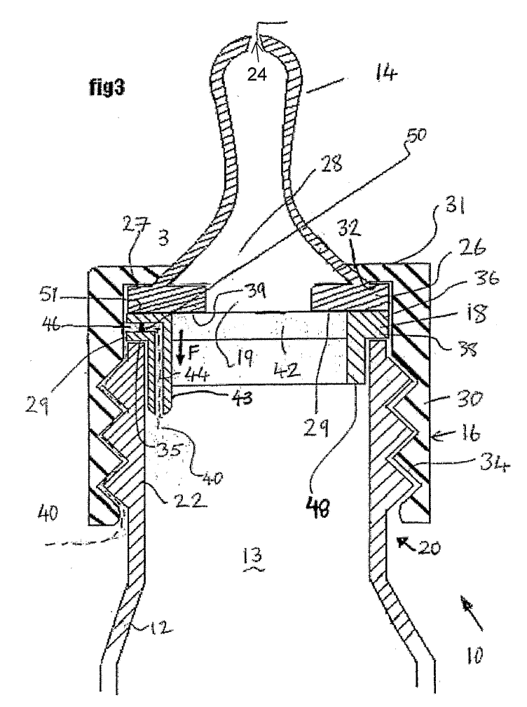

FIG. 2 is a sectional front view of part of the bottle assembly of FIG. 1,

FIG. 3 is a sectional front view showing part of the bottle assembly of FIG. 1,

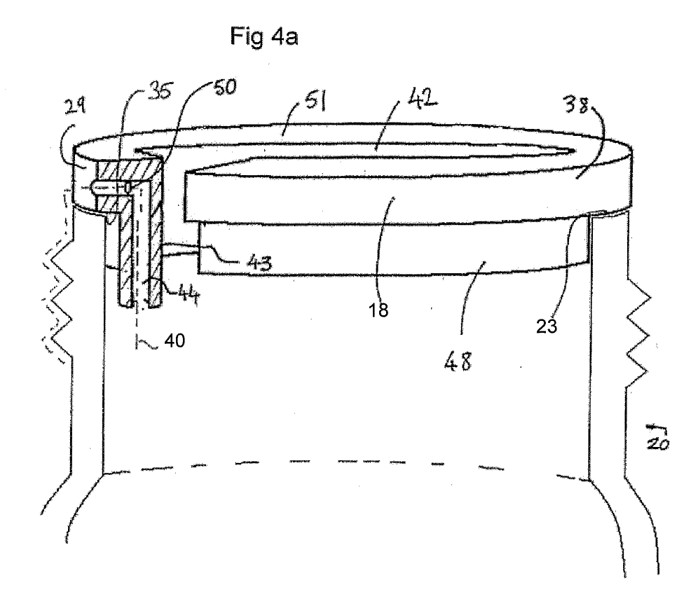

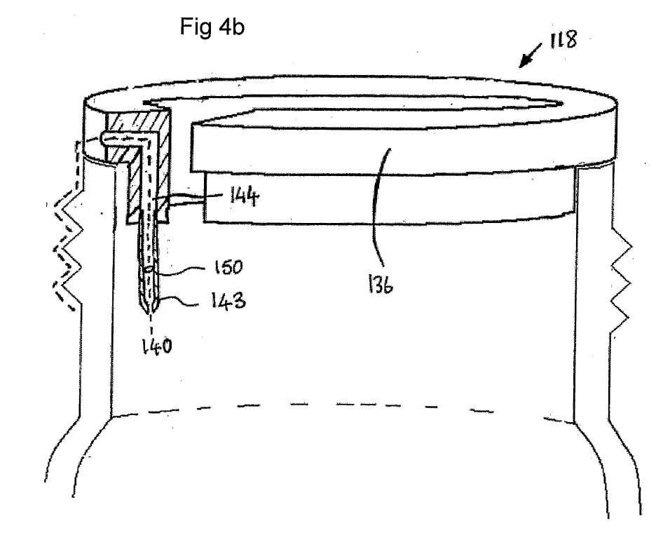

FIG. 4A is a part-sectioned perspective view showing part of the bottle assembly of FIG. 1,

FIG. 4B is a part-sectioned perspective view of the bottle assembly of FIG. 1 including an alternative vent device,

FIG. 5 is a perspective view of part of the bottle assembly of FIG. 1 including an alternative vent device,

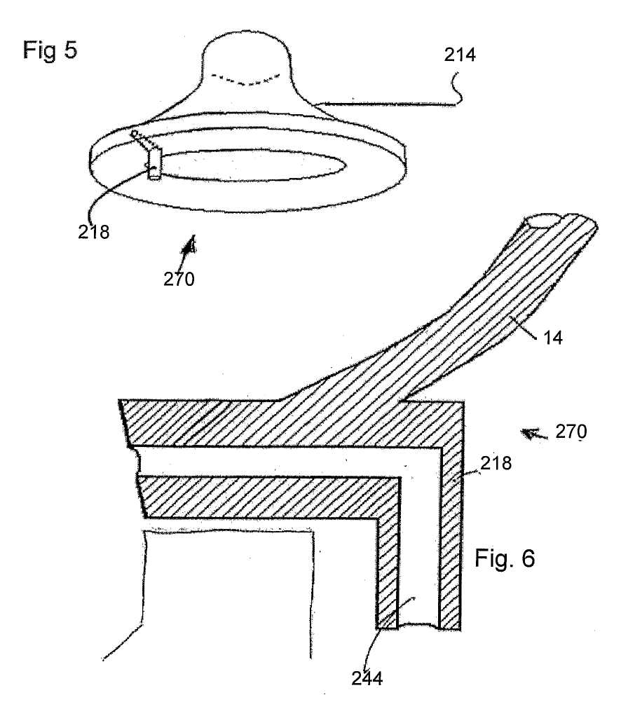

FIG. 6 is a sectional front view of the vent device of FIG. 5,

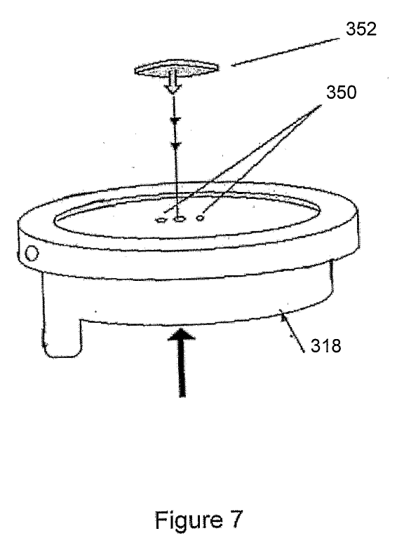

FIG. 7 is a perspective view of an alternative vent device,

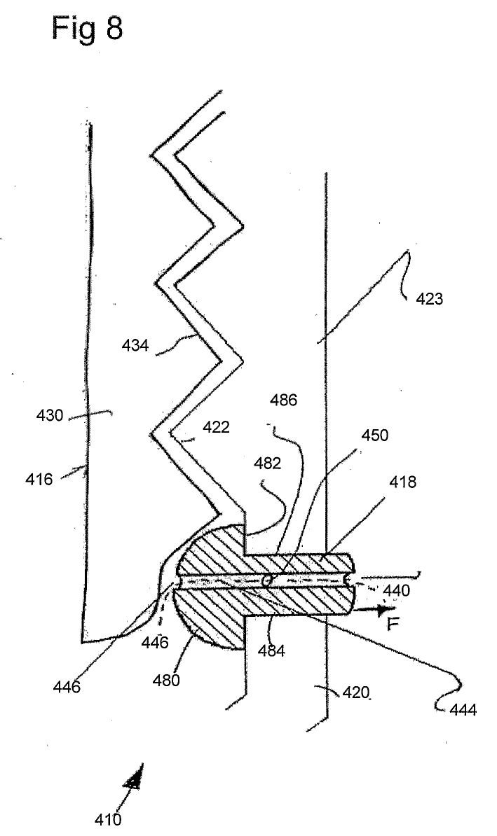

FIG. 8 is a sectional front view showing part of a bottle assembly according to a second embodiment of the present invention,

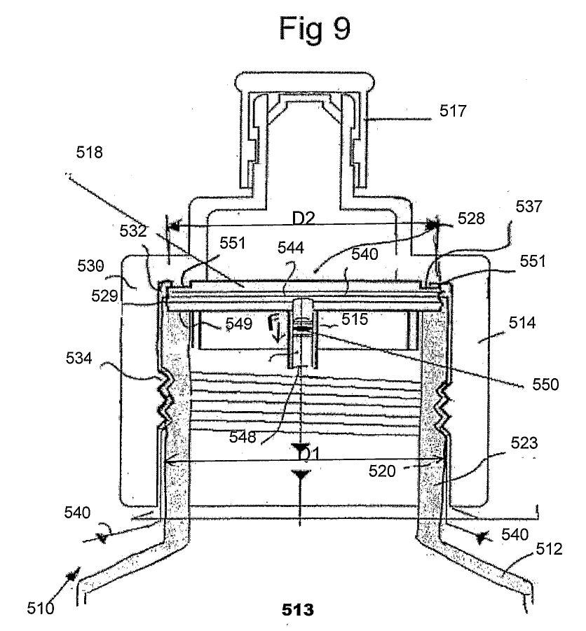

FIG. 9 is a sectional front view showing part of a bottle assembly according to a third embodiment of the present invention,

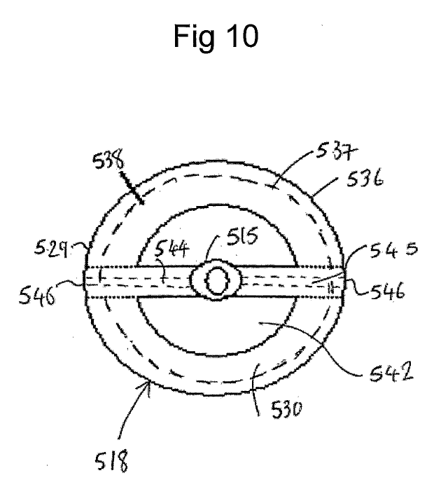

FIG. 10 is a plan view of the vent device of the bottle assembly of FIG. 9,

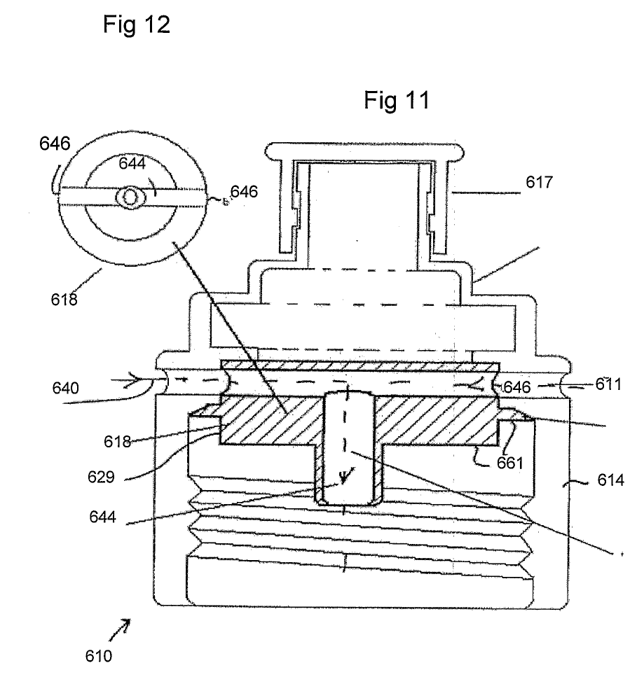

FIG. 11 is a sectional front view showing part of a bottle assembly according to a fourth embodiment of the present invention,

FIG. 12 is a plan view of the vent device of the bottle assembly of FIG. 11,

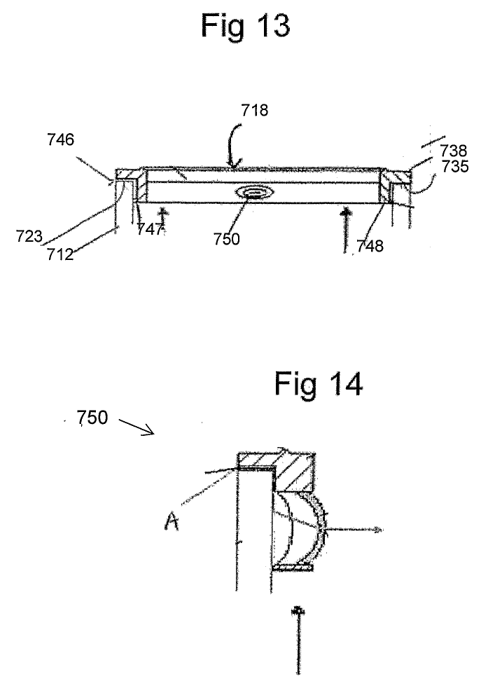

FIG. 13 is a part-sectioned side view showing the vent device of a fifth embodiment of the present invention,

FIG. 14 is a perspective view showing the vent device of FIG. 13,

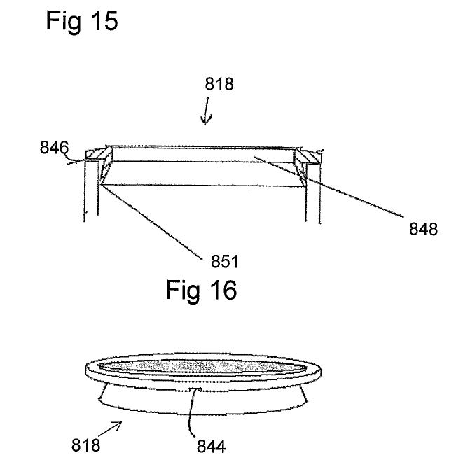

FIG. 15 is a part-sectioned side view showing the vent device of a sixth embodiment of the present invention,

FIG. 16 is a perspective view showing the vent device of FIG. 15,

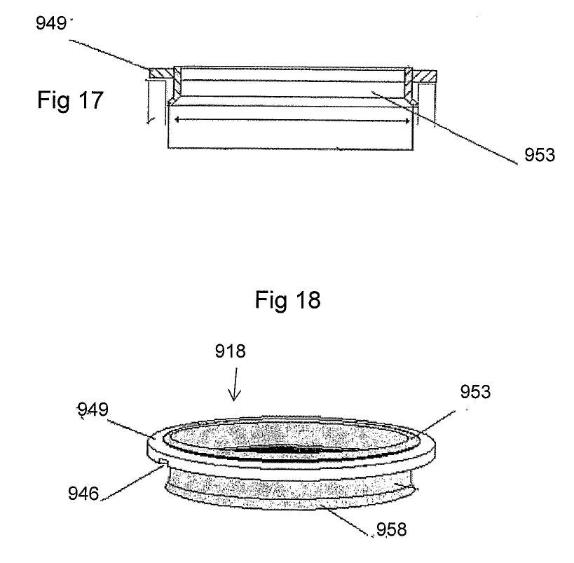

FIG. 17 is a part-sectioned side view showing the vent device of a seventh embodiment of the present invention,

FIG. 18 is a perspective view showing the vent device of FIG. 17,

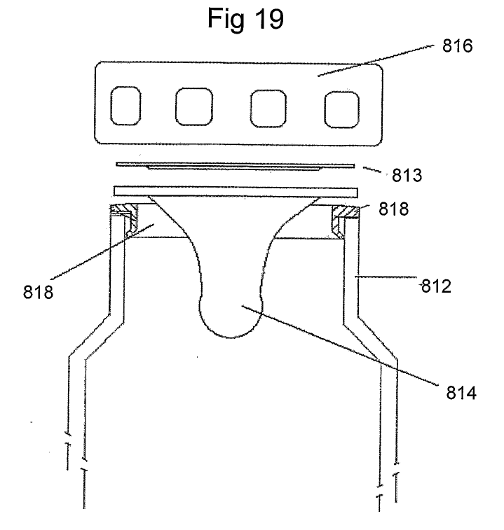

FIG. 19 is a side sectional view of the vent device of FIG. 15 in situ with the teat of the bottle inverted, and

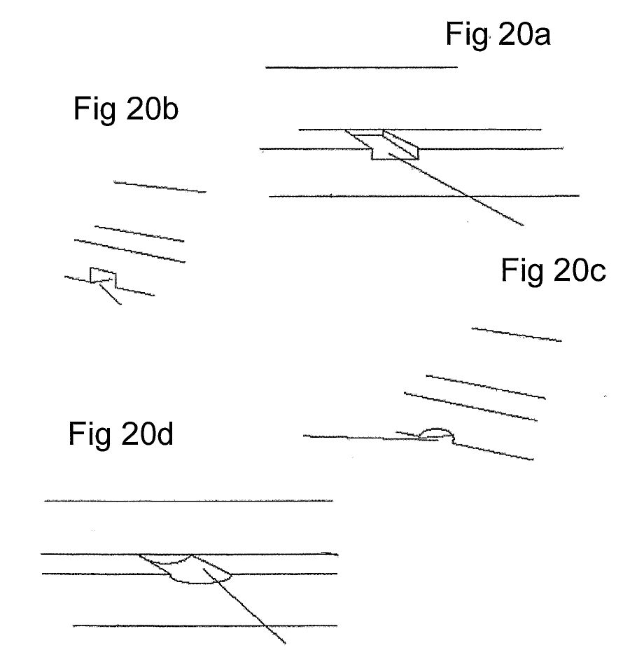

FIGS. 20a, b, c and d are perspective views of inlets and grooves for vent devices in accordance with the invention.

With reference to FIGS. 1 to 4A, there is shown a bottle assembly in the form of a baby bottle assembly 10, including a bottle 12, a closure comprising a collar 16 and a teat 14, and a vent device 18.

The bottle 12, teat 14, and collar 16 are well known components and have not been modified in any way.

The bottle 12 is cylindrical and includes a neck 20, the neck having a bottle threaded portion 22 of diameter D1 and a rim 23. The bottle 12 defines a chamber 13 which receives a fluid, for example liquid feed (not shown).

The teat 14 is cone-like in shape, having an annular flange 26 around the base thereof defining a lower aperture 19. The annular flange 26 has an upper surface 27 and a lower surface 39 (best seen in FIG. 3). The teat also has an upper aperture 24 at the tip thereof. Typically, the teat is made from silicone rubber.

The collar 16 comprises an internally threaded cylindrical side wall 30, and a top wall 31 which extends radially inwardly from the side wall (best seen in FIG. 3). The top wall 31 has an interior surface 32, which defines an aperture 28.

The vent device 18 comprises a stepped cylindrical body 36. The body 36 comprises a first cylinder 38 having an external diameter D2 and a second cylinder 48 having an external diameter D3 which is less then D2. The first and second cylinders have a common internal diameter which defines a fluid flow aperture 42.

The first cylinder 38 has a top surface 51 and a bottom surface 35, with an edge surface 29 defined therebetween. The second cylinder 48 has a lower face with a vent projection 43 extending axially therefrom.

A vent aperture 44 is formed through the body 36. The vent aperture 44 is L-shaped in section and extends from the edge surface 29 of the first cylinder 38 radially thereof, and then axially through the second cylinder 48 and the vent projection 43. It can be seen that the vent aperture 44 does not extend into the fluid flow aperture 42. The vent aperture defines a vent inlet 46 on the edge surface 29.

A one way valve 50 is located within and is integral with the vent aperture 44, so as to permit air flow in the direction of arrow F.

Assembly of the bottle assembly 10 is as follows:

The vent device 18 is arranged onto the bottle 12 such that the bottom surface 35 of the first cylinder 38 contacts the bottle rim 23 (best seen in FIG. 4A), and the second cylinder 48 extends into the neck 20 of the bottle. The stepped profile of the vent device 18 enables easy location onto the bottle rim 23. It can be seen from FIG. 1 that the diameter D2 of the first cylinder 38 is less than the diameter D1 of the bottle threaded portion 22 to prevent obstruction of the collar 16. The diameter D3 is just less than internal diameter of the bottle neck.

The collar 16 and teat 14 are assembled such that the teat 14 partially protrudes through the aperture 28 (as shown in FIG. 1), with the upper surface 27 of the lower flange 26 in contact with the interior surface 32 of the top wall 31 of the collar (best seen in FIG. 3).

The collar 16 is then threaded onto the bottle 12, until the lower surface 39 of the teat 14 is in contact with the top surface 51 of the vent device 18, and the bottom surface 35 of the vent device 18 is in contact with the bottle rim 23. Sufficient tightening of the collar enables the vent device 18 to form a seal between the teat 14 and the bottle rim 23.

It can be seen from FIG. 3 that once assembled, the vent device 18 is disposed between the teat 14 and the bottle rim 23, and that the vent inlet 46 is covered by the side wall 30 of the collar 16.

Once assembled, a vent path (indicated by broken line 40) is defined by the vent aperture 44 and the gap between the bottle threaded portion 22 and the internally threaded cylindrical side wall 30 of the collar.

It can also be seen from FIG. 3 that a fluid path is defined between the chamber 13 and the exterior by the vent device fluid aperture 42, the lower teat aperture 19, the collar aperture 28, and the teat upper aperture 24.

The bottle assembly functions as follows.

Firstly, the bottle is tilted by a feeder, for example a parent (not shown).

A baby then sucks on the teat 14, such that the liquid feed passes from the chamber 13 to the baby's mouth via the fluid path.

As the liquid feed passes from the bottle, a partial vacuum is created in the chamber 13, thereby creating a pressure differential between the chamber and the exterior of the bottle.

As a result of the pressure differential, air is vented through the vent path 40 into the chamber 13. Thus, the pressure differential is minimised as air is automatically vented into the chamber. The vented air passes into the liquid feed and, since the bottle is tilted, rises to the surface, away from the teat. For this reason, the vent outlet can be submerged, and it is not necessary to extend the vent projection further into the chamber such that it vents above the liquid feed surface. However, in alternative embodiments the vent projection can extend different lengths into the bottle, for example, the vent projection can extend so that it is proximate the bottom of the bottle. This reduces even more the possibility of air being mixed with liquid feed close to the teat.

The fact that the vent inlet 46 is covered by the collar 16 reduces the likelihood of the vent path becoming covered by the hands (not shown) of the feeder, thereby ensuring that venting is not prevented during feeding.

Thus it can be seen that the vent path 40 allows air to be vented into the chamber 13 from the exterior of the bottle, and therefore air is not vented into the chamber 13 via the teat aperture 24. Since there is no mixing of air and liquid feed in the teat 14, the associated problems this causes, such as colic and wind, are less likely to arise.

Furthermore, the fact that the pressure differential is minimised due to the air being automatically vented into the chamber, reduces the effort required by the baby when sucking liquid feed from the chamber.

Additionally, there is less likelihood of the teat 14 collapsing since the pressure differential is minimised.

In this embodiment it can be seen that the vent device 18 both allows air to be vented into the chamber 13, and the provision of the one way valve 50, in combination with the seal formed between the vent device 18 and the bottle rim 23, and the vent device 18 and the teat 14, prevents liquid feed leaking from the bottle 12.

Thus the present invention provides a simple vent device which allows air to be vented into the bottle, prevents leakage from the bottle, and can be added to known baby bottles without any modification of the other components, i.e. the bottle, teat, and collar.

In another embodiment, the vent aperture could be formed within the vent device such that instead of having a single vent inlet on edge surface, there are a plurality of vent inlets. This could be achieved, for example, by forming an annular aperture within the first cylinder, with radial apertures extending from the annular aperture such that each radial aperture defines a vent inlet on the edge surface. The axial part of the vent aperture in the second cylinder is arranged such that it is in fluid communication with the annular aperture, and therefore a vent path is defined by the axial part of the vent aperture, the annular aperture, and the radial aperture. The one-way valve is arranged within or on the axial part of the vent aperture. It is important that the one-way valve is located upstream of the annular and radial apertures so that only one valve is required to prevent fluid leaking from the bottle via the annular and radial apertures.

By providing a plurality of vent inlets the vent efficiency is increased. Furthermore, if one of the vent inlets becomes blocked, for example, with liquid feed, there are other vent inlets though which air can vent.

In another embodiment, an aperture can be provided in the wall of the collar so that air vents both through the gap between the threaded portions, and through the aperture in the collar, thereby increasing vent efficiency.

In this embodiment, the vent device is provided as a separate component which is advantageous since it can be used with known bottles. The vent device can be purchased individually for customers already owning a baby bottle, or provided as an option when purchasing a new bottle.

It will be appreciated that to fit bottles having different diameter rims, a vent device having a cylindrical body of appropriate diameter is used.

In FIG. 4B, there is shown an alternative vent device 118 comprising a stepped cylindrical body 136 and a separate vent projection 143, i.e. the vent projection is not integral with the stepped cylindrical body as in the vent device of FIG. 4A. In this embodiment, the one way valve 150 is provided in the vent projection. It will be appreciated that, as in the case of the vent device shown in FIG. 4A, to fit bottles having different diameter rims, it is necessary to select a vent device having a body with an appropriate diameter. However, in the embodiment of FIG. 4B, the same vent projection can be used regardless of the diameter of the stepped cylindrical body.

It will be appreciated that in this embodiment, the vent projection is arranged on the vent device such that it is not in the fluid flow path, i.e. it is offset from the fluid flow aperture 42. This has the advantage that fluid flow is not significantly disrupted by the vent projection. In other embodiments, the vent projection can be arranged such that it is not offset from the fluid flow apertures, for example, located centrally within the fluid flow aperture.

In another embodiment, the teat and the vent device can be integrated, and therefore supplied as a separate subassembly for insertion between the bottle and the collar. By integrating the vent device and the teat there is a reduction in the number of components, and hence assembly costs. Furthermore, the seal between the teat and the vent device is no longer reliant on tightening up the collar. Such an integrated subassembly 270 is shown in FIGS. 5 and 6, where it can be seen that the vent device 218 and teat 214 are combined. Such a one-piece component is easier to sterilise since the surface area is reduced.

Alternatively, it is possible integrate the vent device with the bottle as opposed to the teat.

With reference to FIG. 7, there is shown an alternative vent device 318 which is identical to the vent device of FIGS. 1 to 4A except the vent device 318 includes a plurality of fluid apertures 350 which can be opened and closed using a fluid valve plug 352. In other embodiments, another type of valve may be used to control fluid flow from the chamber. Thus the valve plug 352 and apertures 350 cooperate to control the flow of liquid feed from the chamber.

Assembly of the vent device into the bottle is identical to the embodiment of FIGS. 1 to 4A.

The bottle assembly functions in an identical manner to the bottle assembly of FIGS. 1 to 4A, with the exception that the flow of liquid feed from the chamber to the exterior is controlled by the fluid valve plug 352. This is particularly advantageous for babies with eating difficulties, where some control over the liquid feed flow is required.

Thus it is possible with the vent device 318 to control both liquid feed flow and vent air into the chamber.

With reference to FIG. 8 there is shown an alternative bottle assembly 410, which is identical to the bottle assembly of FIGS. 1 to 4A except that an alternative vent device 418 is employed. Features similar or identical to the bottle assembly of FIGS. 1 to 4 are numbered 400 greater.

The vent device 418 includes a head 480 with an inside surface 482, and a shank 484 with an outer surface 486. The vent device 418 includes a vent aperture 444 which extends through the head 480 and the shank 484. The vent aperture defines a vent inlet 446.

Typically, the head 480 has a diameter of 5 mm, the shank 484 a diameter of 3 mm, with an overall insert length of 6 mm. The diameter of the vent aperture 444 is typically 1.5 mm

A one way valve 450 is located within and is integral with the vent aperture 444, so as to permit air flow in the direction of arrow F.

Assembly of the bottle assembly 410 is identical to the bottle assembly of FIGS. 1 to 4A, except that in this embodiment, the vent device 418 is not disposed between the teat and the bottle, but is assembled as follows:

The vent device 418 is inserted onto the neck 420 of the bottle 412 such that the shank 480 penetrates through the neck 420, with the inside surface 482 of the head 480 in contact with the neck 420.

In other embodiments, an aperture can be preformed in the bottle to allow insertion of the venting insert, with the vent device being retained in the neck via a screw-fit, or an interference fit.

By whatever means the shank is inserted into the neck, the fit between the outer surface 480 and the neck 420 is such that a seal is formed therebetween to prevent leakage of liquid feed from the chamber.

The collar 416 and teat (not shown in FIG. 8 but identical to the teat of FIGS. 1 to 4A) are assembled in the same way as the bottle assembly of FIGS. 1 to 4A.

The collar 416 is then threaded onto bottle 412 in the same way as in the bottle assembly of FIGS. 1 to 4A, except that in this embodiment, since the vent device is no longer disposed between the teat and the bottle, a seal is formed directly between the teat 414 and the bottle 412 as the collar is tightened. Thus, advantageously, the seal between the vent device 418 and the bottle 412 is not dependent on the tightening of the collar 416.

It can be seen from FIG. 8 that once assembled, the vent inlet 446 is covered by the side wall 430 of the collar, and therefore the vent inlet is less likely to become covered, and venting is ensured.

Once assembled, a vent path (indicated by broken line 440) is defined by the vent aperture 444, and a portion of the gap between the bottle threaded portion 422 and the collar threaded portion 434.

The bottle assembly functions in the same way as the bottle assembly of FIGS. 1 to 4A, except that air is only vented through part of the length of the threaded portions and not the entire length of the threaded portions.

In this embodiment it can be seen that the vent device allows air to be vented into the chamber, and the provision of the one way valve, in combination with the seal formed between the vent device and the bottle neck, and the teat and the bottle, prevents liquid feed leaking from the bottle.

In an alternative embodiment, the vent device can be positioned on the neck portion of the bottle such that air is vented directly into the vent aperture, i.e. not via the gap between the threaded portions, but arranged such that vent inlet 446 is still covered by part of the collar so as to prevent it becoming covered.

It will be appreciated that the vent device of FIG. 8 can be integrated with the bottle during manufacture, or provided as a separate component to use with known bottles.

The use of the vent device of FIG. 8 offers an alternative simple vent device which can be added to known baby bottle assemblies, the vent device preventing leakage from the bottle, and allowing venting of air into the chamber.

With reference to FIG. 9, there is shown an alternative bottle assembly 510.

In contrast to the embodiments of FIGS. 1 to 8, bottle assembly 510 is a sports drink bottle assembly.

The bottle assembly 510 includes a bottle 512, a closure in the form of cap 514, and a vent device 518.

The bottle 512 and cap 514 are known components and have not been modified in any way.

The bottle 512 is cylindrical and includes a neck 520, the neck having a bottle threaded portion 522 of diameter D1 and a rim 523. The bottle 512 defines a chamber 513 which receives fluid, for example water (not shown). Any fluid can be used, including carbonated liquids.

The cap 514 comprises an internally threaded cylindrical side wall 530, and a top wall 531 which extends radially inwardly from the side wall. The top wall 531 has an interior surface 532 which defines an aperture 528. The top wall 531 has an annular seal 551 formed thereon.

The cap 514 further includes a fluid valve 517 located thereon which can move between open and closed positions in a known way thereby allowing water to pass from the chamber to the user under the control of the user.

The vent device 518 is a substantially cylindrical body having an outer wall 536. The outer wall 536 has an external diameter D2. The outer wall 536 has an upper surface 533, with an annular groove 537 formed thereon, a lower surface 549, and an edge surface 529 defined therebetween. The outer wall 536 of the venting insert is bridged by a bridge portion 545. A fluid aperture 542 is formed through the insert between the outer wall and the bridge portion. The vent device 518 includes a vent projection 515 located at the midpoint on the bridge portion 545.

A vent aperture 544 is formed through the body of the vent device and extends from the edge surface 529 radially thereof through the bridge portion 545, and then axially through the vent projection 515. The vent aperture 544 defines vent inlets 546 on the edge surface 529.

A one way valve 550 is located within and is integral with the vent aperture 544, so as to permit air flow in the direction of arrow F.

Assembly of the bottle assembly 510 is as follows:

The vent device 518 is inserted into the cap 514 such that the annular groove 537 locates on the annular seal 551.

The cap 514 is then threaded onto bottle 512 by engagement of the threaded portions 520,522. After the cap 514 has been fully threaded onto the bottle 512, the lower surface 549 and the edge surface 529 of the vent device 518 are in contact with the bottle rim 523, and the annular groove 537 of the vent device 518 is in contact with the annular seal 551 of the cap 514. Sufficient tightening of the cap enables the vent device 518 to form a seal between the cap 514 and the bottle rim 523.

It can be seen from FIG. 9 that once assembled, the vent device 518 is disposed between the cap 514 and the bottle rim 523, and that the vent inlets 546 are covered by the side wall 530 of the cap 514.

Once assembled, a vent path (indicated by line 540) is defined by the vent aperture 544 and the gap between the bottle threaded portion 522 and the internally threaded side wall 530.

The bottle assembly 510 functions in an identical manner to the bottle assembly of FIGS. 1 to 4A, except instead of a baby sucking on the teat, a user (not shown) moves the fluid valve 517 such that it is open to allow fluid flow, and then squeezes the bottle or sucks on the fluid valve such that the water passes from the chamber 513 to the user.

The fact that the pressure differential is minimised due to the air being automatically vented into the chamber, reduces the effort required by the user when drinking from the chamber and reduces the amount of deformation of the bottle required.

Furthermore, because the bottle will not collapse due to the fact the pressure is equalised, the strength requirement of the bottle is reduced, and therefore it is possible to make the bottle from cheaper and thinner materials.

It is also possible to provide a plurality of vent inlets in the vent device to increase vent efficiency in the same way as described in relation to the embodiment of FIGS. 1 to 4A.

In another embodiment, an aperture is provided in the cap of the bottle assembly so that air can vent into the bottle via the gap between the threaded portions and through the aperture in the cap, thereby increasing vent efficiency.

It will be appreciated that instead of providing a vent device that is disposed between the fluid outlet and the bottle, it is possible to employ the vent device 418 of FIG. 8 onto the neck portion 520 of the drink bottle 512.

It will also be appreciated that the vent projection can be provided as a separate component, i.e. not integral with the body of the vent device, in the same way as shown in FIG. 4B. This allows the same sized vent projection to be used with vent devices of different diameters.

With reference to FIGS. 11 and 12, there is shown an alternative bottle assembly 610. Features similar or identical to the bottle assembly of FIGS. 9 and 10 are numbered 100 greater.

The bottle assembly 610 is identical to the bottle assembly 510, except that firstly, a different vent device 618 is employed, and secondly, the cap 614 has been modified to include a slot 611.

In contrast to the embodiment of FIGS. 9 and 10, the vent device 618 is integral with the cap 614. The edge surface 629 of the vent device 618 is modified such that it corresponds and forms a seal with the inside of the cap 614, there being no need for the annular seal used in the embodiment of FIGS. 9 and 10.

The vent device 618 has a lower surface 661. The vent device 618 is arranged on the cap 614 such that the vent inlets 646 align with the slot 611. The vent device 618 is dimensioned such that it forms an interference fit with the cap 614, and is therefore retained within the cap. Alternatively, a suitable adhesive can be used to retain the vent device within the cap.

Assembly of the bottle assembly 610 is identical to the bottle assembly of FIGS. 9 and 10, except that in this embodiment the vent device 618 is already provided on the cap 614, and therefore there is no need to pre-assemble the vent device into the cap 614 prior to threading the cap 614 onto the bottle.

Once the cap 614 has been screwed onto the bottle threaded portion (not shown in figure but identical to the bottle of FIG. 9 and 10), the lower surface 661 of the vent device 618 is in contact with the bottle rim so as to form a seal between the bottle rim and the vent device 618. The vent device 618 is already sealed against the cap 614 by virtue of the fact that it is integral with it, and therefore the venting insert 618 forms a seal between the bottle rim and the cap.

Once assembled, a vent path (indicated by broken line 640) is defined by the vent aperture 644 and the slot 611 of the cap.

The bottle assembly 610 functions in an identical manner to the bottle assembly 510, except that air is vented into the chamber via the slot 611 and vent aperture 644, as opposed to via the gap between the threaded portions. Thus in this embodiment, the threaded portions are not relied upon for venting, and any blockages that might occur, for example due to liquid contamination in the threaded area, do not affect venting efficiency.

In another embodiment, the vent aperture can be formed in the vent device in a similar way as described in relation to the embodiment of FIGS. 1 to 4A, such that the vent aperture has a plurality of vent inlets, i.e. in this case more than two vent inlets.

Further embodiment of vent device 718, 818, 918 are shown in FIG. 13 to 18. Features similar or identical to the bottle assembly of FIGS. 1 and 4a are numbered 700, 800 and 900 greater respectively. The bottle assemblies in each can be identical to the bottle assembly 10, but with a different vent device 718, 818, 918 is employed.

Referring to FIG. 13 the vent device 718 is arranged onto the bottle 712 such that the bottom surface 735 of the first cylinder 738 contacts the bottle rim 723, and the second cylinder 748 extends into the neck 720 of the bottle. The stepped profile of the vent device 718 enables easy location onto the bottle rim 723.

The two main differences from device 18 are the vent inlet 746 and the one way valve 750. The vent inlet 746 and aperture 744 are simply a shaped, such as square or rounded, groove in the top cylinder 748. This is perhaps best seen in FIGS. 15 and 18 in which inlets 846 and 946 are shown which are substantially identical. This inlet is very easy to clean, even by dishwasher, since it is open on one side.

Vent device 718 also comprises a lip 747 which extends all the way around the circumference of the bottom of second cylinder 748 sealing the fluid from the inlet 746. The vent path through device 719 is defined by the inlet 748 and then the one way valve 750.

One way valve 750 is shown in FIG. 14 in the open position where it can be seen that air is able to bellow the valve 750 outwards to let air through- as shown by pathway A. Working in the opposite direction, the valve will be pushed shut by fluid pressure preventing any fluid ingress

Vent device 718 can be of one material and moulded as one piece making it a cheep component to manufacture. It can also be retro fitted to any suitably sized bottle without modification being made to the bottle.

The fluid flow aperture 742 may have a fluid flow valve fitted similar to components 350, 352 shown in FIG. 7. Additionally there may be any number of inlets/apertures 746/744.

Device 818 is shown in FIGS. 15 and 16 and is a substantially similar to device 718 except that rather than a lip 747 and valve 750 the device has a flexible seal 851. This extends all around the circumference of device 818 with no gaps. Fluid pressure forces the flexible seal 751 against the bottle 812 and prevents fluid flowing out. In the opposite direction air through inlet 848 is able to push the flexible seal 851 to complete the vent path. Device 818 is of a flexible plastic or rubber construction and is preferably one piece.

Device 918 is shown in FIGS. 17 and 18 and is a substantially similar to device 818 except that it is of a two piece construction. Device 918 comprise a rigid plastic outer ring 949 and a silicon rubber central section 953. Ring 949 forms most of the first cylinder 938, and section 953 forms all of second cylinder 948, and flexible seal 951. Section 953 sealably fits into ring 949 so that the device 918 in situ works in the same manner as device 818.

A further advantage of vent devices 718, 818 and 918 is that the teat 714, 814, 914 can be inverted into the bottle 712, 812, 912 with the vent unit 718, 818, 918 in situ. In FIG. 18 this is shown with vent device 814. In this figure a blanking cap 813 and collar 816 are foxed to the top of the bottle 812 providing a good seal against leakages and a smaller overall unit for storage. With known bottles teat inversion in storage relies on a top dome cap which frequently leaks when the push fit dome cap is dislodged.

As an alternative to the embodiments shown in FIGS. 13 to 18, devices, need not have an inlet 746, 846 or 946. Instead the vent path can be defined by a similarly shaped groove on the rim 723 of the bottle. Examples of possible shapes of such inlets, and grooves are shown in FIGS. 19a, b, c and d.

In the embodiments of FIGS. 9 to 12, it is possible to include a shut-off device on the assembly to prevent air entering the chamber when it is not required to be vented, thereby reducing the risk of contaminating the chamber if the bottle is to be left standing for a period of time. It is also possible to arrange the shut-off device so that it operates with the fluid valve 517,617, and therefore when the fluid valve is closed, no air can vent into the chamber, and conversely, when fluid is being drunk from the bottle, air can vent into the chamber.

In the embodiments of FIGS. 1 to 12 the threaded portions on both the bottle, and the collar/cap are continuous. It is also possible to use discontinuous threaded portions on the collar/cap and/or the bottle, for example by providing one or more vertical grooves which cross over the threaded portions. By using a discontinuous threaded portion, there is an increased vent area between the threaded portions, and therefore vent efficiency is increased. Furthermore, the use of a discontinuous thread or threads helps address the potential reduction in vent efficiency if the threads become contaminated with liquid.

It will be understood that the vent devices described in the embodiments of FIGS. 1 to 12 can be easily adapted to fit known different sized bottles by simply increasing or decreasing the size of the vent device.

It will be appreciated that any known type of one-way valve may be used in the present invention, providing it can be incorporated on the vent device. For example, a ball-type one-way valve can be used. In the case where the valve is integral with the vent device, the valve can be provided by forming a block in the vent aperture, and then providing a slit in the block to prevent fluid from passing.

It will be understood that the present invention is not to be restricted to baby bottles, and sports drinks bottles, and is applicable to any bottle where venting is required.

1. A vent device for a bottle, the vent device comprising a vent aperture and a one-way valve in fluid communication with the vent aperture, a vent path being defined by the vent aperture.

2. A bottle assembly including a bottle having an opening for receiving a fluid, a closure for closing the opening, the closure having a fluid outlet to enable egress of the fluid from the bottle, and a vent device, the vent device comprising a one-way valve, a vent path being defined by the one-way valve from the exterior to the interior of the bottle, the vent path being different from the fluid outlet, whereby the vent path permits air to vent into the bottle on creation of a partial vacuum as a result of the fluid passing to the exterior of the bottle via the fluid outlet.

3. A bottle assembly according to claim 2 in which the vent device comprises a vent aperture in fluid communication with the one-way valve.

4. A bottle assembly according to claim 2, in which the closure and the bottle define a gap, the vent path being defined by the gap and the vent aperture.

5. A bottle assembly according to claim 4, in which the closure has a closure threaded portion, the bottle having a bottle threaded portion, in which the gap is defined between the threaded portions.

6. A bottle assembly according to claim 5 in which one or both of the threaded portions are discontinuous.

7. A bottle assembly according to claim 2, in which the vent device has a vent inlet, which, in use, is substantially covered by the closure, thereby preventing the vent inlet from being blocked.

8. A bottle assembly according to claim 5 in which the vent device is disposed between the bottle and the closure.

9. A bottle assembly according to claim 8 in which the vent device is releasably secured between the bottle and the closure due to engagement between the threaded portions.

10. A bottle assembly according to claim 8 in which the vent device forms a seal between the bottle and the closure.

11. A bottle assembly according to claim 2 in which the vent device is disposed on a neck of the bottle.

12. A bottle assembly according to claim 11 in which the vent device is secured to the neck via a screw fit, or an interference fit.

13. A bottle assembly according to claim 2 in which the vent device is integral with the bottle.

14. A bottle assembly according to claim 2 in which the vent device is integral with the closure.

15. A bottle assembly according to claim 2 in which the closure includes a closure vent aperture which forms part of the vent path.

16. A bottle assembly according to claim 2 in which the bottle is one of a baby bottle or a sports drink bottle.

17. A bottle assembly according to claim 2 in which the vent device includes a shut-off device operable between an open position whereby air is able to vent into the bottle, and a closed position whereby air is not able to vent into the bottle.

18. A bottle assembly according to claim 17 further including a fluid valve operable between an open position whereby the fluid is able to flow from the bottle, and a closed position whereby the fluid is not able to flow from the bottle.

19. A bottle assembly according to claim 18 in which the shut-off device and the fluid valve are arranged such that closing the fluid valve closes the shut-off device.

20. A bottle assembly according to claim 19 in which opening the fluid valve opens the shut-off device.

21. A vent device or a bottle assembly according to claim 1, in which the vent device comprises a body and a vent projection, the body including part of the vent aperture, the vent projection including part of the vent aperture, wherein both parts of the vent aperture are in fluid communication.

22. A vent device or a bottle assembly according to claim 21 in which the vent projection is releasably attachable to the body.

23. A vent device or a bottle assembly according to claim 22 in which the vent body is selected from a plurality of vent bodies having a different diameter so as to correspond to the diameter of a known bottle, and the vent projection is the same size for all vent body diameters.

24. A vent device or a bottle assembly according to claim 21 in which the one-way valve is provided on the vent projection.

25. A vent device or a bottle assembly according to claim 1 in which the vent device is annular.

26. A vent device or a bottle assembly according to claim 25, in which the vent device has an outer wall, in which the outer wall has a stepped profile.

27. A vent device or a bottle assembly according to claim 26 in which the vent device has an annular outer wall, and the annular outer wall has a stepped profile.

28. A vent device or a bottle assembly according to claim 27 in which the stepped profile is defined by a first stepped portion which locates on a neck of a bottle, and a second stepped portion which locates in a neck of a bottle.

29. A vent device or a bottle assembly according to claim 28 in which the vent aperture comprises a bore through the first and second stepped portions.

30. A vent device or a bottle assembly according to claim 21 in which the vent device includes a fluid aperture to allow fluid to pass therethrough.

31. A vent device or a bottle assembly according to claim 30 in which the vent projection is offset from the fluid aperture.

32. A vent device or a bottle assembly according to claim 1 in which the vent aperture comprises a plurality of vent inlets in fluid communication with the one-way valve.

33-35. (canceled)
